(19) United States
(12) Patent Application Publication
(10) Pub. No.: US 2008/0182003 A1
(43) Pub. Date: Jul. 31, 2008

(54) Production of Sheeted Fruit and Vegetable Snacks

(76) Inventors: Rosemary Shine Baker, Carrollton, TX (US); Brenda K. Cremer, Salem, OR (US); Thomas George Crosby, Frisco, TX (US); Henry Kin-Hang Leung, Plano, TX (US); Bridget Manis, Frisco, TX (US); Carla Mejia, Plano, TX (US); Kelly Sam Miller, The Colony, TX (US); Nancy J. Moriarity, Richardson, TX (US); Jason Thomas Niermann, Frisco, TX (US); Timothy F. Root, Medford, OR (US); Mark W. Sheppard, Oregon City, OR (US); Jim Stalder, Dallas, TX (US); Beverly L. Waters, Cedar Hill, TX (US); Jo Ellen Wayne, Tualatin, OR (US)

Correspondence Address: CARSTENS & CAHOON, LLP, P O BOX 802334, DALLAS, TX, 75380, US

(21) Appl. No.: 11/669,751

(22) Filed: Jan. 31, 2007

(51) Int. Cl. A21D 10/00

(52) U.S. Cl. 426/549

(57) ABSTRACT

The present invention discloses formulations for sheeted, baked fruit and vegetable chips that have a light, crispy texture similar to a potato chip. The ingredients are combined with water and oil to make a dough, which is then sheeted and cut into pieces. The pieces are baked to produce vegetable and fruit snack chips.

### BACKGROUND OF THE INVENTION

1. Technical Field

The present invention relates to a method for making an improved baked snack food and more particularly to a method for making a baked, sheeted snack food having high contents of fruits or vegetables and a shape and texture similar to a potato crisp.

2. Description of Related Art

Baked snack foods such as potato chips are popular consumer items for which there exists a great demand. Potato chips have a light, crispy texture and can be prepared by cooking slices of whole potatoes. They can also be created by using potato flakes and water to create a starchy dough. The dough is sheeted, cut into pieces of a desired shape, and cooked. The dough is compressed between a pair of counter rotating sheeter/cutter rollers that are located closely together, thereby providing a pinch point through which the dough is formed into sheets and cut into a desired shape. Often the desired snack piece shape is that of a square or circle. After the dough is cut into pieces, the pieces are transported towards and through an oven, which reduces their moisture content. The snack pieces are then sent to be packaged.

Although potatoes fall into the broad category of vegetables, the nutritional benefits offered by potatoes are different from the nutritional benefits offered by other more colorful, less starchy vegetables. Because potato starch is the main source of nutrition in conventional potato chips, a snack chip that prominently features other vegetables as additional sources of nutrition is an improvement over potato chips.

In recent years, consumer demand has been dramatically increasing for healthy foods in general, and healthy snack foods in particular. Nutritious snacks can ideally meet several criteria that include limits on the amount of fat, including saturated and trans-fatty acids, cholesterol, sodium, and added sugar. Preferably, the criteria should also include products formulated to have specific health or wellness benefits. Specifically, a nutritious snack might contain, per 1 ounce serving, no more than 5 g of fat, low in saturated fat, zero trans-fatty acids, less than 25% calories from added sugar, and no more than 240 milligrams of sodium.

Fruits and non-starchy vegetables are generally good sources of vitamins, minerals and other healthy compounds such as anti-oxidants. Different fruits and vegetables are rich in different nutrients, and the United States Department of Agriculture (USDA) recommends consumption of between 5 and 13 servings of a variety of fruit and vegetables per day, depending on the specific individual's needs. According to the Food and Drug Administration, a diet that is high in fiber can reduce a person's risk of certain cancers, diabetes, digestive disorders, and heart diseases, as well as aid weight management. Furthermore, vitamins and minerals are widely recognized as part of a healthy diet, and antioxidants may reduce the risk of heart disease and cancer.

Prior art fruit and vegetable snack foods generally take the form of dehydrated slices of whole fruits or vegetables. These prior art dehydrated slices are not sheeted snack chips and do not have the light, crispy texture desired by consumers. Sheeted fruit or vegetable chips in the prior art have included trivial or insubstantial amounts of fruit or vegetables, thus they are not nutritionally different from traditional potato chips. No prior art snack food has been able to deliver high levels of fruits or vegetables, along with the additional hallmarks of nutritious snacks listed above, in the form of a light, crispy snack chip produced from sheeted dough. Consequently, the need exists for a healthy, nutritious snack chip having a high content of fruits or vegetables and a light, crispy texture.

### SUMMARY OF THE INVENTION

The present invention thus provides a great tasting, healthy snack chip having a high content of fruit or vegetable solids, and a form and texture similar to a potato chip. In one embodiment, the snack chip of the present invention preferably has at least ⅓ serving of vegetables or fruit per 1 ounce serving of snack chips. In another embodiment, the snack chip of the present invention has at least ½ serving of vegetables or fruit per 1 ounce serving. In still another embodiment, the snack chip of the present invention has at least 1 serving of vegetables or fruit per 1 ounce serving.

In one aspect of the invention, a powdered blend of fruit solids is used as a healthy ingredient in sheeted, baked snack chips. In another aspect of the invention, a powdered blend of vegetable solids is used as a healthy ingredient in sheeted, baked snack chips. In yet another aspect of the invention, blends of modified starch, whole oat flour, lice flour and potato flakes are used to give the snack chips a light, crispy texture similar to a potato chip. These as well as additional features and advantages of the present invention will become apparent in the following written description.

### BRIEF DESCRIPTION OF THE DRAWINGS

The novel features believed characteristic of the invention are set forth in the appended claims. The invention itself, however, as well as a preferred mode of use, further objectives and advantages thereof, will be best understood by reference to the following detailed description of illustrative embodiments when read in conjunction with the accompanying drawings, wherein:

FIG. 1 is a flowchart indicating the processing steps for the present invention.

### DETAILED DESCRIPTION

The baked snack chips of the present invention are high in vegetable or fruit content. The nutritional goals for the snack chips of the present invention include, per 1 ounce serving of snack chips: no more than 5 g of fat, 1 gram or less of saturated fat, zero trans-fatty acids, less than 25% calories from added sugar, and no more than 240 milligrams of sodium. As used herein, the term fruit is used in the culinary sense and includes those botanical fruits that are sweet and fleshy. Examples of fruit include, without limitation, apple, strawberry, blueberry, cranberry, plum, peach, mango, banana, pear, grape and orange. The term vegetable is used herein in the culinary sense and includes those plant fruits that are savory, as opposed to sweet. The term vegetable, as used herein, only includes non-starchy vegetables and specifically excludes potatoes and other starchy vegetables, such as sweet potatoes, sweet corn, yams, taro, plantains, green peas and lentils. Examples of non-starchy vegetables include, without limitation, pumpkin, tomato, onion, bell pepper, beet, cucumber, broccoli and squash. Each of the different fruits and non-starchy vegetables used in the present invention are rich in different nutrients and have nutritional benefits different from potatoes and other starchy vegetables.

The ingredient that gives the baked chips of the present invention their high content of vegetables and fruits is a powderized blend of several different fruits or vegetables. In one preferred embodiment, the baked chips of the present invention incorporate at least ⅓ serving of fruits or vegetables per 1 ounce serving of the snack chips. In another preferred embodiment, the baked chips of the present invention incorporate at least ½ serving of fruits or vegetables per 1 ounce serving of the snack chips. In yet another preferred embodiment, the baked chips of the present invention incorporate at least 1 serving of fruits or vegetables per 1 ounce serving of the snack chips.

The United States Department of Agriculture (USDA) defines a serving of vegetables as ½ cup of chopped vegetables. For example, ½ cup of 1 inch cubes of raw pumpkin constitutes 1 serving of pumpkin, and ½ cup of chopped or sliced raw tomatoes constitutes 1 serving of tomato under the USDA guidelines. A serving of vegetables can be understood as having a moisture content and a solids content. Vegetable solids and fruit solids are defined herein as the non-water components of vegetables and fruits, respectively. Thus, a serving of vegetables comprises a vegetable solids content on a dry basis and a serving of fruit comprises a fruit solids content on a dry basis. The USDA National Nutrient Database for Standard Reference defines the weight of the edible portion of a vegetable in that ½ cup and defines the average moisture and thus the vegetable solids content of the edible portion of a vegetable. Table 1, for example, depicts the nutrient profile for 1-cup or 180 grams of a red, ripe, raw, year round average tomato as accessed at http://www.nal.usda.gov/fnic/foodcomp/search/.

TABLE 1
Tomatoes, red, ripe, raw, year round average

| | | | | | 1.00 × 1 cup, |
|---|---|---|---|---|---|
| | | | Number | | chopped |
| | | Value per | of Data | Std. | or sliced |
| Nutrient | Units | 100 grams | Points | Error | 180 g |
| Proximates | | | | | |
| Water | g | 94.50 | 33 | 0.159 | 170.10 |
| Energy | kcal | 18 | 0 | | 32 |
| Energy | kj | 75 | 0 | | 135 |
| Protein | g | 0.88 | 19 | 0.039 | 1.58 |
| Total lipid (fat) | g | 0.20 | 26 | 0.034 | 0.36 |
| Ash | g | 0.50 | 19 | 0.018 | 0.90 |
| Carbohydrate, by | g | 3.92 | 0 | | 7.06 |
| difference | | | | | |
| Fiber, total dietary | g | 1.2 | 5 | 0.234 | 2.2 |
| Sugars, total | g | 2.63 | 0 | | 4.73 |
| Sucrose | g | 0.00 | 12 | 0.002 | 0.00 |
| Glucose (dextrose) | g | 1.25 | 16 | 0.135 | 2.25 |
| Fructose | g | 1.37 | 17 | 0.073 | 2.47 |
| Lactose | g | 0.00 | 9 | 0 | 0.00 |
| Maltose | g | 0.00 | 9 | 0 | 0.00 |
| Galactose | g | 0.00 | 4 | 0 | 0.00 |
| Starch | g | 0.00 | 4 | 0 | 0.00 |

USDA National Nutrient Database for Standard Reference, Release 19 (2006)

As used herein, a serving of fruit or a serving of vegetables is defined as the amount of fruit solids or vegetable solids content that is equivalent to ½ cup (118 cubic centimeters) of chopped fruit or vegetables on a dry basis based on the USDA National Nutrient Database for Standard Reference, Release 19, 2006, which is incorporated herein by reference. According to Table 1, one cup of red, ripe, raw, year round average tomatoes weighs 180 grams, has a water content of 94.5% by weight and a vegetable solids content of 5.5%. One vegetable serving of raw tomatoes (½ cup) has a total weight of 90 grams. Consequently, 4.95 grams (5.5% solids content×90 grams total weight) of tomato solids in a finished product is equivalent to one serving of vegetables. (As known to those skilled in the art, vegetable powders typically have an intrinsic moisture component, e.g., tomato powder may comprise less than about 4% moisture by weight. Consequently, the amount of tomato powder needed for one serving of vegetables may not exactly correspond to the amount of tomato solids needed for one serving of vegetables.) Thus, a snack chip having a one-third vegetable serving would have approximately 1.65 grams of tomato solids in a 1 ounce serving of chips, a snack chip having a one-half vegetable serving would have approximately 2.48 grams of tomato solids in a 1 ounce serving of chips, and a snack chip having one vegetable serving would have approximately 4.95 grams of tomato solids in a 1 ounce serving of chips. Consequently, in one embodiment, vegetable powder can be added in an amount sufficient to provide for a one-third vegetable serving, in a preferred embodiment in an amount sufficient to provide for a one-half vegetable serving, and in another preferred embodiment in an amount sufficient to provide for one vegetable serving. As used herein, one serving of fruit or one serving of vegetables is defined as the amount of fruit or vegetable solids that is equivalent to ½ cup (118 cubic centimeters) of a chopped fruit or vegetables on a dry basis based on the USDA National Nutrient Database for Standard Reference, Release 19, 2006, which is incorporated herein by reference.

In one preferred embodiment of the present invention, vegetable powder is used as an ingredient in dough that is sheeted, cut into pieces of a desirable shape and cooked to produce vegetable chips. The term vegetable powder, as used herein, is defined as partially dehydrated flakes of vegetable solids. Typically, vegetable powder will contain between about 1% and about 4% moisture. Vegetable powder may also contain ingredients such as rice flour and/or lecithin as processing aids. In one embodiment, the vegetable powder contains pumpkin, tomato, onion, bell pepper, and beet. In a more preferred embodiment, the vegetable powder comprises about 35% to about 45% pumpkin, about 35% to about 45% tomato, about 10% to about 15% onion, about 5% to about 10% bell pepper, and less than about 3% beet. In another embodiment, the vegetable powder contains pumpkin, tomato, and onion. In a more preferred embodiment, the vegetable powder comprises about 75% to about 85% pumpkin, about 5% to about 15% tomato, and about 5% to about 15% onion. These ingredients are preferred due to considerations such as taste, cost, color, browning characteristics during cooking and vegetable solids content per serving.

In another preferred embodiment of the present invention, fruit powder is used as an ingredient in dough that is sheeted, cut into pieces of a desirable shape and cooked to produce fruit chips. The term fruit powder, as used herein, is defined as partially dehydrated flakes of fruit solids. Typically, fruit powder will contain between about 1% and about 4% moisture. Fruit powder may also contain ingredients such as rice flour and/or lecithin as processing aids. In one embodiment, the fruit powder contains apple. In another embodiment, the fruit powder contains apple, blueberry, cranberry, and strawberry. In a more preferred embodiment, the fruit powder comprises about 80% to about 90% apple, about 3% to about 8% strawberry, about 3% to about 8% blueberry, and about 3% to about 8% cranberry. In still another embodiment, the fruit powder contains apple, peach and mango. In a more preferred embodiment, the fruit powder comprises at least about 95% apple, at least about 1% peach and at least about 1% mango. These ingredients are preferred due to considerations such as flavor (sweetness), cost, color, sugar content and fruit solids content.

To produce both the fruit chips and the veggie chips, the fruit or vegetable powders are mixed with dry ingredients, water and oil to form a dough. Optionally, natural or artificial colors can be included as ingredients in the dough. The other dry ingredients help maintain dough cohesiveness and expansion during cooking, and contribute to the final product light, crispy texture and enhanced flavor, among other things. The other dry ingredients are comprised of a dry matter component and a moisture component. The dry matter component of any dry ingredient, as that term is used herein, is defined as the non-water components of that particular dry ingredient. For example, potato flakes have a potato flakes dry matter component and a potato flakes moisture component. The potato flakes dry matter component is defined as all of the non-water components that make up the potato flakes. The moisture component of each dry ingredient, as used herein, is defined as the water component of each dry ingredient.

Thus, the moisture component for the potato flakes is defined as all of the water in the potato flakes. The moisture component of each dry ingredient will typically be less than about 10.5% by weight of the particular dry ingredient.

In one embodiment rice flour is included as an ingredient in the dough to maintain cohesiveness, contribute to the final product texture and reduce breakage of the final product. The rice flour has a rice flour dry matter component and a moisture component. In a more preferred embodiment, the rice flour is pre-gelatinized rice flour. Pre-gelatinized rice flour is rice flour that has a starchy component that has undergone an irreversible loss of molecular order, which allows it to more easily form pastes or gels when mixed with water. An example of pre-gelatinized rice flour suitable for use in the present invention can be obtained from Sage V Foods, under the brand RF GLX080.

In one embodiment, potato flakes are included as an ingredient to help the dough expand as it cooks, and give the final product its light, crispy texture. The potato flakes have a potato flakes dry matter component and a moisture component. Potato flakes are made from potatoes that have been cooked, mashed, and dried. For example, Idaho Pacific Corporation in Ririe, Id. produces potato flakes under the brand name Potato Flakes #124 that can be used as herein described.

In one embodiment, modified starch is included as an ingredient in the dough to aid cohesiveness, expansion, texture, and breakage reduction. The modified starch has a modified starch dry matter component and a moisture component. An example of a modified starch that can be used in the present invention is XPAND′R starch, available from AE Staley Manufacturing Company, headquartered in London, U.K.

In another embodiment, whole oat flour (one suitable example of which is available from Can-Oat Milling, headquartered in Manitoba, Canada) is included as an ingredient to improve the flavor of the final product and to enhance the nutritional value of the snack by adding whole grain fiber, vitamins and minerals. Whole oat flour has a whole oat flour dry matter component and a moisture component.

In still another embodiment, a mixture of mono-, di-, and/or tri-glycerides are included as an ingredient to reduce the “pillowing” or “blistering” effect that can take place during cooking by providing small vents that allow steam to escape while the snack chip is cooking. The mixture of glycerides has a dry matter component and a moisture component. In another embodiment, hard stock beads are used in place of the glycerides mixture to reduce pillowing or blistering. Hard stock beads, as used herein, are defined as small granules of glycerides which are made of hydrogenated edible oils or non-hydrogenated, high melting fraction of edible oil having a predetermined particle size distribution. A preferred particle size distribution for the hard stock beads is as follows: about 0.58% sit on a U.S. #18 mesh screen, about 18.90% sit on a U.S. #30 mesh screen, about 65.62% sit on a U.S. #60 screen, and about 14.90% pass through a #60 U.S. mesh screen. The melting point of these hard stock glycerides is preferably between about 49° C. and about 82° C., more preferably between about 57° C. and about 79° C., and in the preferred embodiment between 60° C. and 71° C. Glycerides encompassing a range of Iodine Values less than 80 can meet these melting point needs. Examples of other lipids that can be used with the present invention include DATEMs, propylene glycol esters, polyglycerol esters, as well as waxes, sterols and other higher melting lipid compounds. One example of hard stock beads that are suitable for use in the present invention are described in U.S. Pat. No. 6,893,673—Method For Controlling Snack Product Blistering Through The Use Of Solid Lipid Particles, which is owned by the same assignee as the present application. As used herein, the term “glycerides” is defined as covering both the mixture of mono-, di- and/or tri-glycerides and hard stock beads.

In one preferred embodiment of the vegetable chips, water and corn oil are mixed with the vegetable powder and dry ingredients to make a dough high in vegetable content. The resultant dough comprises about 5% to about 15% modified starch, about 10% to about 30% rice flour, about 3% to about 12% whole oat flour, about 10% to about 30% potato flakes, at least 8% vegetable powder, less than about 3% corn oil, less than about 1% glycerides and about 30% to about 40% water. All percentages used herein are by weight unless otherwise noted.

In a more preferred embodiment of the vegetable chips, the resultant dough comprises about 7% to about 14% modified starch, about 15% to about 25% rice flour, about 5% to about 10% whole oat flour, about 15% to about 25% potato flakes, at least 9% vegetable powder, less than about 3% corn oil, less than about 1% glycerides and about 32% to about 38% water.

In a most preferred embodiment of the vegetable chips, the resultant dough comprises about 8% to about 13% modified starch, about 16% to about 23% rice flour, about 5% to about 8% whole oat flour, about 16% to about 23% potato flakes, at least 10% vegetable powder, less than about 3% corn oil, less than about 1% glycerides and about 33% to about 37% water.

In one preferred embodiment of the fruit chips, water and corn oil are mixed with the fruit powder and dry ingredients to make a dough high in fruit content. The resultant dough comprises about 5% to about 15% modified starch, about 8% to about 20% rice flour, about 3% to about 15% whole oat flour, about 8% to about 20% potato flakes, at least 12% fruit powder, less than about 3% corn oil, less than about 1% glycerides and about 27% to about 37% water.

In a more preferred embodiment of the fruit chips, the resultant dough comprises about 6% to about 13% modified starch, about 9% to about 18% rice flour, about 4% to about 12% whole oat flour, about 9% to about 19% potato flakes, at least 13% fruit powder, less than about 3% corn oil, less than about 1% glycerides and about 28% to about 36% water.

In a most preferred embodiment of the fruit chips, the resultant dough comprises about 7% to about 12% modified starch, about 10% to about 17% rice flour, about 5% to about 10% whole oat flour, about 10% to about 18% potato flakes, at least 15% fruit powder, less than about 3% corn oil, less than about 1% glycerides and about 30% to about 35% water.

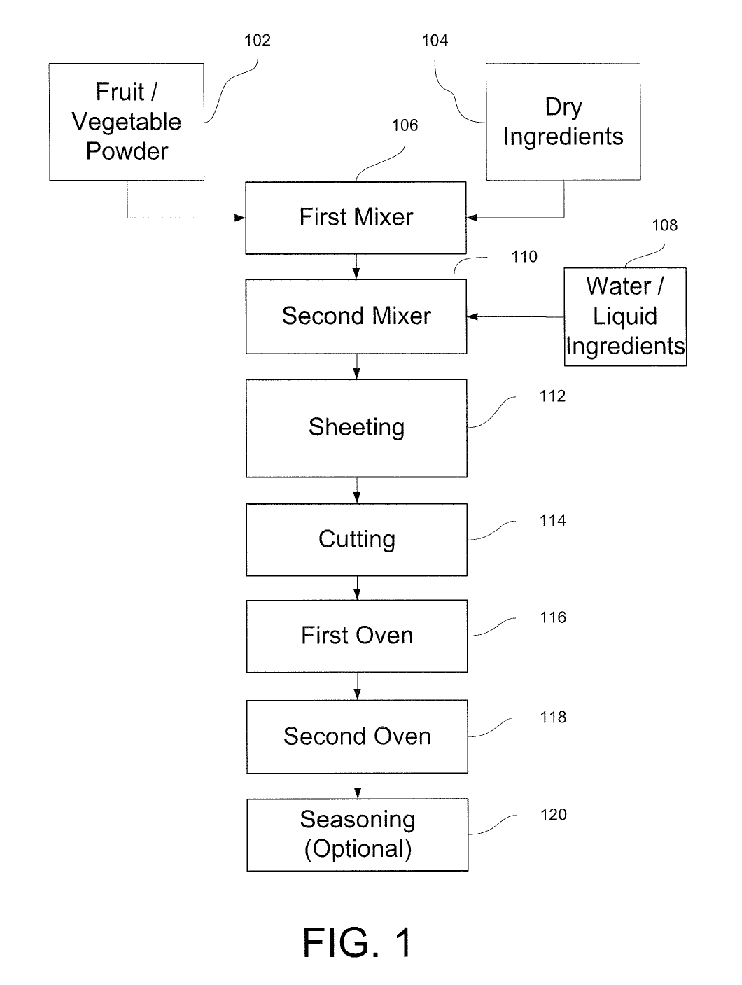

Referring to FIG. 1, therein is depicted a flowchart indicating the general processing steps for producing the fruit and vegetable chips of the present invention. In the first processing step, the vegetable or fruit powder 102 and other dry ingredients 104 are mixed in a first mixer 106. These ingredients are then combined with water and other liquid ingredients 108 in a second mixer 110 to produce a dough. The mixing may occur at room temperature, generally about 68° F. to about 86° F., but preferably occurs at chilled temperatures, with the ambient temperature being between about 45° F. and 65° F. and with the mixer being chilled using water at above about 35° F. The dough preferably exits the second mixer between about 60° F. and about 80° F. Controlling the water temperature helps to control the dough temperature.

The dough then undergoes a sheeting step 112, whereby the dough is compressed between at least one pair of counter rotating sheeter/cutter rollers that are located closely together, thereby providing a pinch point through which the dough is formed into sheets. The sheet of dough for the fruit chips is preferably between about 0.027 inches and about 0.035 inches thick, and more preferably about 0.033 inches thick after the sheeting step. The sheet of dough for the veggie chips is preferably between about 0.031 inches and about 0.039 inches, and more preferably about 0.035 inches after the sheeting step. The preferred thickness is preferably accomplished by passing the dough through several successive stages of rollers, with each successive stage having the rollers located progressively closer together, more preferably 2, 3 or 4 stages of rollers. Passing the dough through several stages of rollers minimizes the amount of work done on the dough during the sheeting step by any particular set of rollers, thereby reducing the influence of the sheeting step on the physical properties of the dough that are established during the mixing step. In some cases, especially during sheeting of the stickier fruit chip dough, the rollers are preferably chilled to between about 35° F. and about 65° F. to reduce the likelihood of the dough sticking to the rollers.

The sheet of dough is then cut into a plurality of pieces 114, preferably using a rotary cutting unit. The pieces are then baked in a first oven 116 at an oven temperature between about 350° F. and about 540° F. until they have a moisture content of about 5% to about 15%. The pieces are then baked in a second oven 118 at an oven temperature between about 235° F. and about 280° F. to form vegetable or fruit chips having a final moisture content between about 2% and about 4% of the total product weight. The snack food can then optionally be seasoned 120 in an oil spray and seasoning tumbler and then packaged. For the fruit chips, the seasoning can optionally include aromatic compounds that impart a fruity smell onto the snack chips.

The resultant vegetable chip in one preferred embodiment comprises about 10% to about 16% modified starch dry matter, about 20% to about 30% rice flour dry matter, about 5% to about 15% whole oat flour dry matter, about 20% to about 30% potato flakes dry matter, at least 14% vegetable solids, less than about 3% coin oil and less than about 4% water. The resultant vegetable chip in another preferred embodiment comprises about 12% to about 14% modified starch dry matter, about 23% to about 27% rice flour dry matter, about 8% to about 12% whole oat flour dry matter, about 23% to about 29% potato flakes dry matter, at least 15% vegetable solids, less than about 3% corn oil and less than about 4% water.

The resultant fruit chip in one preferred embodiment comprises about 10% to about 16% modified starch dry matter, about 15% to about 25% rice flour dry matter, about 5% to about 15% whole oat flour dry matter, about 15% to about 25% potato flakes dry matter, at least about 20% fruit solids, less than about 3% corn oil and less than about 4% water. The resultant fruit chip in another preferred embodiment comprises about 12% to about 15% modified starch dry matter, about 18% to about 22% rice flour dry matter, about 8% to about 12% whole oat flour dry matter, about 18% to about 22% potato flakes dry matter, at least about 20% fruit solids, less than about 3% corn oil and less than about 4% water.

### FIRST EXAMPLE

The table below illustrates the ingredients and their relative amounts that were used to make a vegetable chip dough according to the present invention:

TABLE 2

| Ingredient | Wt. % Dry Ingredients | Wt. % Dough |
|---|---|---|
| Modified Starch | 13.51% | 9.22% |
| Rice Flour | 27.82% | 18.99% |
| Whole Oat Flour | 10.15% | 6.93% |
| Potato Flakes | 27.31% | 18.64% |
| Vegetable Powder | 16.35% | 11.16% |
| Sugar (granulated) | 3.06% | 2.09% |
| Corn Oil | — | 1.05% |
| Glycerides | 0.77% | 0.53% |
| Lecithin Powder | 1.03% | 0.70% |
| Added Water | — | 30.69% |

The table below illustrates the relative amount of each ingredient's dry matter and the relative amount of water remaining in the fully cooked, unseasoned vegetable chips produced using the dough ingredients and relative amounts listed in Table 2 above.

TABLE 3

| Constituent | Wt. % Final Product |
|---|---|
| Modified Starch Dry Matter | 13.21% |
| Rice Flour Dry Matter | 25.76% |
| Whole Oat Flour Dry Matter | 9.40% |
| Potato Flakes Dry Matter | 26.13% |
| Vegetable Solids | 16.41% |
| Sugar Dry Matter | 3.15% |
| Corn Oil | 1.59% |
| Glycerides Dry Matter | 0.80% |
| Lecithin Dry Matter | 1.05% |
| Water | 2.50% |

In this embodiment, the vegetable powder and other dry ingredients were mixed together in a batch mixer. Next, the well mixed dry ingredients, water and oil were combined in a twin screw continuous wet mixer for about 30 to about 60 seconds to create the dough. The dough exited the mixer at between 68° F. and 88° F. The dough was then sheeted using 4 stages of rollers to produce a sheet of dough about 0.035 inches thick. The sheet of dough then passed through a rotary cutting step that produced a plurality of square shaped, ridged pieces of dough. The pieces were then baked in an 8-zone Wolverine jet impingement oven at 375° F. to 500° F. to produce partially baked snack pieces having a total moisture content between 5% and 15% by weight. The partially baked pieces were then allowed to cool. The cooled pieces were then dried in a 2 zone Wenger convection oven at 260° F. to 280° F. until the pieces had a final moisture content between 2% and 4%. The final snack pieces were then seasoned using a tumbler, where they were lightly sprayed with oil and seasoning.

### SECOND EXAMPLE

The table below illustrates the ingredients and their relative amounts that were used to make a fruit chip dough according to the present invention:

TABLE 4

| Ingredient | Wt. % Dry Ingredients | Wt. % Dough |
|---|---|---|
| Modified Starch | 13.59% | 9.45% |
| Rice Flour | 21.64% | 15.04% |
| Whole Oat Flour | 10.20% | 7.09% |
| Potato Flakes | 20.69% | 14.38% |
| Fruit Powder | 25.03% | 17.40% |
| Sugar (granulated) | 6.12% | 4.26% |
| Corn Oil | — | 1.08% |
| Glycerides | 0.78% | 0.54% |
| Lecithin Powder | 1.03% | 0.72% |
| Monocalcium Phosphate | 0.52% | 0.36% |
| Sodium Bicarbonate | 0.40% | 0.28% |
| Added Water | — | 29.40% |

The table below illustrates the relative amount of each ingredient's dry matter and the relative amount of water remaining in the fully cooked, unseasoned fruit chips produced using the dough ingredients listed in Table 4 above.

TABLE 5

| Ingredient | Wt. % Final Product |
|---|---|
| Modified Starch Dry Matter | 13.20% |
| Rice Flour Dry Matter | 19.89% |
| Whole Oat Flour Dry Matter | 9.38% |
| Potato Flakes Dry Matter | 19.66% |
| Fruit Solids | 24.94% |
| Sugar Dry Matter | 6.26% |
| Corn Oil | 1.59% |
| Glycerides Dry Matter | 0.79% |
| Lecithin Dry Matter | 1.05% |
| Monocalcium Phosphate Dry Matter | 0.53% |
| Sodium Bicarbonate Dry Matter | 0.41% |
| Water | 2.30% |

In this embodiment, the fruit powder and other dry ingredients were mixed together in a batch mixer. Next, the well mixed dry ingredients, water and other liquid ingredients were combined in a twin screw continuous wet mixer for about 30 to about 60 seconds to create the dough. The dough exited the mixer at between 68° F. and 88° F. The dough was then sheeted using 4 stages of rollers to produce a sheet of dough about 0.033 inches thick. The sheet of dough then passed through a rotary cutting step that produced a plurality of square shaped pieces of dough. The pieces were then baked in an 8-zone Wolverine jet impingement oven at 350° F. to 540° F. to produce partially baked snack pieces having a total moisture content between 5% and 15% by weight. The partially baked pieces were then allowed to cool. The cooled pieces were then dried in a 2-zone Wenger convection oven at 235° F. to 250° F. until the pieces had a final moisture content between 2% and 4%. The final snack pieces were then seasoned using a tumbler, where they were lightly sprayed with oil and seasoning.

The vegetable and fruit chips described in the above examples contained at least ½ serving of vegetables and fruit, respectively. They also had a light, crispy texture similar to that of a potato crisp. In addition, the fruit and vegetable chips disclosed herein met or exceeded the other preferred nutritional goals. Specifically, the chips disclosed above had, per 1 ounce serving, less than 5 g of fat, 1 gram or less of saturated fat, zero trans-fatty acids, less than 25% calories from added sugar, and no more than 240 milligrams of sodium. In sum, the result is a healthy, nutritious snack chip high in vegetable or fruit content and having a light, crispy texture similar to a potato crisp.

What is claimed is:

1. A vegetable chip dough comprising by weight:
about 5% to about 15% modified starch;
about 10% to about 30% rice flour;
about 3% to about 12% whole oat flour;
about 10% to about 30% potato flakes;
at least 8% vegetable powder;
less than about 3% corn oil;
less than about 1% glycerides; and
about 30% to about 40% water.

2. The dough of claim 1 wherein said vegetable powder comprises by weight:
about 35% to about 45% pumpkin;
about 35% to about 45% tomato;
about 10% to about 15% onion;
about 5% to about 10% bell pepper; and
less than about 3% beet.

3. The dough of claim 1 wherein said vegetable powder comprises by weight:
about 75% to about 85% pumpkin;
about 5% to about 15% tomato; and
about 5% to about 15% onion.

4. The dough of claim 1 further comprising by weight:
about 7% to about 14% said modified starch;
about 15% to about 25% said rice flour;
about 5% to about 10% said whole oat flour;
about 15% to about 25% said potato flakes;
at least 9% said vegetable powder; and
about 32% to about 38% said water.

5. The dough of claim 4 wherein said vegetable powder comprises by weight:
about 35% to about 45% pumpkin;
about 35% to about 45% tomato;
about 10% to about 15% onion;
about 5% to about 10% bell pepper; and
less than about 3% beet.

6. The dough of claim 4 wherein said vegetable powder comprises by weight:
about 75% to about 85% pumpkin;
about 5% to about 15% tomato; and
about 5% to about 15% onion.

7. The dough of claim 1 further comprising by weight:
about 8% to about 13% said modified starch;
about 16% to about 23% said rice flour;
about 5% to about 8% said whole oat flour;
about 16% to about 23% said potato flakes;
at least 10% said vegetable powder; and
about 33% to about 37% said water.

8. The dough of claim 7 wherein said vegetable powder comprises by weight:
about 35% to about 45% pumpkin;
about 35% to about 45% tomato;
about 10% to about 15% onion;
about 5% to about 10% bell pepper; and
less than about 3% beet.

9. The dough of claim 7 wherein said vegetable powder comprises by weight:
about 75% to about 85% pumpkin;
about 5% to about 15% tomato; and
about 5% to about 15% onion.

10. A vegetable chip comprising by weight:
about 10% to about 16% modified starch dry matter;
about 20% to about 30% rice flour dry matter;
about 5% to about 15% whole oat flour dry matter;
about 20% to about 30% potato flakes dry matter;
at least 14% vegetable solids;
less than about 3% corn oil; and
less than about 4% water.

11. The vegetable chip of claim 10 wherein said vegetable solids comprise by weight:
about 35% to about 45% pumpkin;
about 35% to about 45% tomato;
about 10% to about 15% onion;
about 5% to about 10% bell pepper; and
less than about 3% beet.

12. The vegetable chip of claim 10 wherein said vegetable solids comprise by weight:
about 75% to about 85% pumpkin;
about 5% to about 15% tomato; and
about 5% to about 15% onion.

13. The vegetable chip of claim 10 wherein said vegetable solids comprise at least one-third serving of vegetables per one ounce serving of vegetable chips.

14. The vegetable chip of claim 10 wherein said vegetable solids comprise at least one-half serving of vegetables per one ounce serving of vegetable chips.

15. The vegetable chip of claim 10 wherein said vegetable solids comprise at least one serving of vegetables per one ounce serving of vegetable chips.

16. The vegetable chip of claim 10 additionally comprising:
less than about 5 grams of fat;
about 1 gram or less of saturated fat;
about 0 grams of trans-fatty acids;
less than about 25% calories from added sugar; and
less than 240 milligrams of sodium.

17. The vegetable chip of claim 10 further comprising by weight:
about 12% to about 14% said modified starch dry matter;
about 23% to about 27% said rice flour dry matter;
about 8% to about 12% said whole oat flour dry matter;
about 23% to about 29% said potato flakes dry matter; and
at least 15% said vegetable solids.

18. The vegetable chip of claim 17 wherein said vegetable solids comprise by weight:
about 35% to about 45% pumpkin;
about 35% to about 45% tomato;
about 10% to about 15% onion;
about 5% to about 10% bell pepper; and
less than about 3% beet.

19. The vegetable chip of claim 17 wherein said vegetable solids comprise by weight:
about 75% to about 85% pumpkin;
about 5% to about 15% tomato; and
about 5% to about 15% onion.

20. A fruit chip dough comprising by weight:
about 5% to about 15% modified starch;
about 8% to about 20% rice flour;
about 3% to about 15% whole oat flour;
about 8% to about 20% potato flakes;
at least 12% fruit powder;
less than about 3% corn oil; and
about 27% to about 37% water.

21. The dough of claim 20 wherein said fruit powder comprises by weight:
about 80% to about 90% apple;
about 3% to about 8% strawberry;
about 3% to about 8% blueberry; and
about 3% to about 8% cranberry.

22. The dough of claim 20 wherein said fruit powder comprises by weight:
at least 95% apple.

23. The dough of claim 20 wherein said fruit powder comprises by weight:
at least about 95% apple;
at least about 1% peach; and
at least about 1% mango.

24. The dough of claim 20 further comprising by weight:
about 6% to about 13% said modified starch;
about 9% to about 18% said rice flour;
about 4% to about 12% said whole oat flour;
about 9% to about 19% said potato flakes;
at least 13% said fruit powder; and
about 28% to about 36% said water.

25. The dough of claim 24 wherein said fruit powder comprises by weight:
about 80% to about 90% apple;
about 3% to about 8% strawberry;
about 3% to about 8% blueberry; and
about 3% to about 8% cranberry.

26. The dough of claim 24 wherein said fruit powder comprises by weight:
at least 95% apple.

27. The dough of claim 24 wherein said fruit powder comprises by weight:
at least about 95% apple;
at least about 1% peach; and
at least about 1% mango.

28. The dough of claim 20 further comprising by weight:
about 7% to about 12% said modified starch;
about 10% to about 17% said rice flour;
about 5% to about 10% said whole oat flour;
about 10% to about 18% said potato flakes;
at least 15% said fruit powder; and
about 30% to about 35% said water.

29. The dough of claim 28 wherein said fruit powder comprises by weight:
about 80% to about 90% apple;
about 3% to about 8% strawberry;
about 3% to about 8% blueberry; and
about 3% to about 8% cranberry.

30. The dough of claim 28 wherein said fruit powder comprises by weight:
at least 95% apple.

31. The dough of claim 28 wherein said fruit powder comprises by weight:
at least about 95% apple;
at least about 1% peach; and
at least about 1% mango.

29. The dough of claim 28 wherein said fruit powder comprises by weight:
about 80% to about 90% apple;
about 3% to about 8% strawberry;
about 3% to about 8% blueberry; and
about 3% to about 8% cranberry.

30. The dough of claim 28 wherein said fruit powder comprises by weight:
at least 95% apple.

31. The dough of claim 28 wherein said fruit powder comprises by weight:
at least about 95% apple;
at least about 1% peach; and
at least about 1% mango.

32. A fruit chip comprising by weight:
about 10% to about 16% modified starch dry matter;
about 15% to about 25% rice flour dry matter;
about 5% to about 15% whole oat flour dry matter;
about 15% to about 25% potato flakes dry matter;
at least 20% fruit solids;
less than about 3% corn oil; and
less than about 4% water.

33. The fruit chip of claim 32 wherein said fruit solids comprise by weight:
about 80% to about 90% apple;
about 3% to about 8% strawberry;
about 3% to about 8% blueberry; and
about 3% to about 8% cranberry.

34. The fruit chip of claim 32 wherein said fruit solids comprise by weight:
at least 95% apple.

35. The fruit chip of claim 32 wherein said fruit solids comprise by weight:
at least about 95% apple;
at least about 1% peach; and
at least about 1% mango.

36. The fruit chip of claim 32 wherein said fruit solids comprise at least one-third serving of fruit per one ounce serving of fruit chips.

37. The fruit chip of claim 32 wherein said fruit solids comprise at least one-half serving of fruit per one ounce serving of fruit chips.

38. The fruit chip of claim 32 wherein said fruit solids comprise at least one serving of fruit per one ounce serving of fruit chips.

39. The fruit chip of claim 32 additionally comprising:
less than about 5 grams of fat;
about 1 gram or less of saturated fat;
about 0 grams of trans-fatty acids;
less than about 25% calories from added sugar; and
less than 240 milligrams of sodium.

40. The fruit chip of claim 32 further comprising by weight:
about 12% to about 15% said modified starch dry matter;
about 18% to about 22% said rice flour dry matter;
about 8% to about 12% said whole oat flour dry matter;
about 18% to about 22% said potato flakes dry matter; and
at least 20% fruit solids.

41. The fruit chip of claim 40 wherein said fruit solids comprise by weight:
about 80% to about 90% apple;
about 3% to about 8% strawberry;
about 3% to about 8% blueberry; and
about 3% to about 8% cranberry.

42. The fruit chip of claim 40 wherein said fruit solids comprise by weight:
at least 95% apple.

43. The fruit chip of claim 40 wherein said fruit solids comprise by weight:
at least about 95% apple;
at least about 1% peach; and
at least about 1% mango.
